(19) United States
(12) Patent Application Publication
(10) Pub. No.: US 2005/0029751 A1
(43) Pub. Date: Feb. 10, 2005

(54) Sealing device for sealing joints, and hollow-profile strip therefor

(76) Inventor: Rene P. Schmid, Oberweningen (CH)

Correspondence Address: PERRY TEITELBAUM;GOODMAN & TEITELBAUM, SUITE 1400, 26 COURT STREET, BROOKLYN, NY, 11242, US

(21) Appl. No.: 10/910,702

(22) Filed: Aug. 3, 2004

(30) Foreign Application Priority Data
Aug. 7, 2003 (DE) 103 36 641.5

(51) Int. Cl. E06B 11/00

(52) U.S. Cl. 277/637

(57) ABSTRACT

The invention relates to a sealing device for sealing joints between abutting concrete structures having an injection-channel body which is to be fitted on a concrete surface and has an injection channel for introducing sealing material, whereby the injection channel has on the joint side at least one outlet opening for the sealing material and a covering strip which prevents the penetration of material through the outlet opening into the injection channel from the joint side, whereby the covering strip is a stop-valve strip in the form of a hollow-profile strip.

The invention relates to a sealing device for sealing joints between structural bodies, in particular between abutting concrete structures, with an injection channel according to the preamble of claim 1. The invention also relates to a sealing device for sealing joints between abutting concrete structures, with an injection channel, according to the preamble of claim 21. The invention additionally relates to a hollow-profile strip therefor.

The brochure entitled “Dichte Bauwerken: Die dichte Arbeitsfuge mit dem COMBIject Quellband-Injektionsschlauch-System [“sealed structures”: the sealed construction joint with the COMBIject swellable strip/injection tube system] discloses a sealing device with an injection-tube body which is made of plastic and on which a covering crosspiece is arranged laterally, with the result that a cross-sectionally angled accommodating space which is open to the bottom and to the sides is formed beneath the crosspiece. Passing through the tube body is an injection channel which is open in a slot-like manner in the downward direction, the slot being covered on the joint side by an open-cell foam strip fitted into it. A swellable strip is arranged in the accommodating space. In order that, for example during assembly, the foam strip and the swellable strip do not fall out of the sealing device, the sealing device is encased by a plastic mesh. The disadvantage is that the swellable strip, as it swells, can press the slot and the cells of the foam strip shut, with the result that the passage of injection material out of the injection channel is at least greatly obstructed and the injection channel is thus incapable of functioning. The sealing device involves very high outlay to produce because the individual parts of the sealing device are difficult to put together for materials supplied by the metre and, in particular, the assembled sealing device also falls apart easily if the sealing device is not encased by the plastic mesh.

DE 41 40 616 A1, FIG. 3, discloses an injection tube which has a tubular body made of plastic with a channel introduced into this body and with outlet openings which lead into the channel from the outer surface of the body. The region of a flat circumferential side on the joint side of the body is adjoined by a swellable strip which extends over the entire length of the injection tube. The embedded channel and the associated outlet channels to the outlet openings are filled with a liquid or solid inert material which can be displaced out of the channel by flushing or by the injection of a sealing material. The body and the swellable strip are each encased by a nonwoven or a woven fabric. This casing is designed such that, when the concrete wall is cast, concrete does not penetrate into the channel and into the outlet channels. However, the material of the casing has to be permeable to the injection medium. It is thus also possible for water and moisture, for example cement slurry, to penetrate into the channel from the outside through the casing and through the outlet channels and, in the process, to block the channels, with the result that the injection channel is no longer capable of functioning. The particular disadvantage is that the outlet channels are at a distance from the joint side; it is thus possible for the swellable strip, as it swells, to block the paths over which the sealing material is distributed from the outlet channels to the joint, with the result that injection material from the outlet channels does not reach the voids of the joint which is to be supplied. The injection tube involves very high outlay to produce because the tube body and the swellable strip each have to be laboriously introduced into a narrow casing tube.

EP 0 418 699 A1, FIG. 5, discloses a sealing device made of a cross-sectionally U-shaped profile which is fitted on a set concrete surface and has a top wall and two side walls. The free longitudinal edges of the side walls of the profile are seated on the concrete surface, with the result that outlet openings for a sealing material are formed between the concrete surface and the longitudinal edges. Provided in the longitudinal direction of the profile, beneath the top wall, is a free through-passage channel for sealing material with a bottom wall which is arranged approximately halfway up the height of the side walls and has a longitudinal slot for sealing material to pass out. Provided beneath the bottom wall is a U-shaped accommodating space, in which an open-cell plastic-foam strip is mounted. The sealing medium is introduced, in the first instance, into the through-passage channel and passes, through the slot in the bottom wall, into the plastic foam in the throughflow channel and, from there, passes beneath the longitudinal edges into that region in the joint, between the first and the second sections which are to be concreted together, which is to be sealed and can accommodate the sealing medium. This sealing device has proven to be extremely successful.

EP 0 804 656, FIG. 3, discloses a sealing device for sealing concrete joints which is in the form of a joint rail and has an injection channel which is designed approximately like the channel according to EP 0 418 699 A1 and has an outlet slot which is covered by a closed-cell foam strip which is impermeable to injection material. If injection material is injected into the injection channel under pressure, the injection material lifts off the foam strip in a valve-like manner and can pass outwards into the joint region. As the pressure decreases, the foam strip leaves the opening again in the manner of a valve. This sealing device functions well.

The object of the invention is to provide a sealing device which satisfies the need for a particularly secure and reliable joint seal which is easy to assemble and handle and to produce and in the case of which, in particular, the situation where material passes into the through-passage channel from the outside is reliably prevented.

The invention achieves the object by a sealing device according to Independent claim 1. The invention also achieves the object by a sealing device according to claim 21. Advantageous embodiments of the invention are characterized in the dependent claims.

According to the invention, the sealing device for sealing joints between abutting concrete structures has an injection-channel body with an injection channel for the introduction of injection material, the injection channel having, on the joint side, at least one outlet opening, e.g. an outlet slot, for the injection material, and also has a tubular stop-valve strip made of an elastic material which prevents material from penetrating via the outlet opening, into the injection channel, from the joint side, the stop-valve strip being designed as a hollow-profile strip. The stop-valve strip is designed to be structured in cross section and yields in a predetermined manner under pressure on the part of the injection material from the outlet slot of the injection channel such that a blocking action of the stop-valve strip is eliminated and the injection material can move out of the channel body in the lateral direction past the stop-valve strip. The sealing device according to the invention functions particularly reliably because the stop-valve strip ensures that the injection channel, and in particular the outlet opening, remains free of contaminants, in particular swelling-up swellable material, which could give rise to blockage. Since the stop-valve strip is designed as a hollow-profile strip, it is possible for the blocking action to be eliminated even at a relatively low pressure on the part of the injection channel. The hollow-profile strip, i.e. the tubular stop-valve strip, is compressible since the walls of the hollow-profile strip can be displaced inwards into the cavity as a result of being correspondingly compliant.

In the case of a particular embodiment of the invention, the channel body has a valve-seat channel for accommodating the stop-valve strip, in particular the hollow-profile strip. The injection channel is connected to the valve-seat channel via the outlet opening, e.g. the outlet slot. The hollow-profile strip can be inserted particularly easily and quickly into the valve-seat channel and is mounted there with a press fit, with the result that it cannot fall out of the valve-seat channel during handling of the sealing device. The stop-valve strip expediently projects out of the valve-seat channel and, when fitted on the concrete surface, is compressed to some extent, this resulting in a defined valve seat.

The hollow-profile strip has, for example, narrow walls and/or longitudinal edges which are supported on associated walls of the valve-seat channel and ensure the press fit of the hollow-profile strip in the valve-seat channel.

The hollow-profile strip has, for example, at least two angled longitudinal walls which are arranged between a bottom wall and a top wall and which each have a region of inflection which, upon compression, forms a predetermined point of inflection. Two mutually opposite inflected walls of the hollow-profile strip preferably form side walls which are supported, in the region of inflection, on the associated walls of the valve-seat channel. The predetermined points of inflection ensure a controlled inflection movement of the walls, in particular such that further-reaching inward inflection produces a defined valve opening between the hollow-profile strip and the walls of the valve-seat channel.

In the case of a further embodiment of the invention, longitudinally extending sealing lips are integrally formed on the side walls of the hollow-profile strip, between the region of inflection and the top wall of the hollow-profile strip, the sealing lips interacting in a sealing manner with the associated side walls of the valve-seat channel and forming the further actual sealing edges or narrow sealing surfaces in the longitudinal direction. Once the hollow-profile strip has been fitted in the valve-seat channel, the sealing lips are pressed against the side walls of the valve-seat channel (press fit). The sealing lips ensure, in the manner of a labyrinth seal, a particularly high level of sealing action of the hollow-profile strip against the penetration of material from the outside into the through-passage channels. The hollow-profile strip is profiled such that it can be compressed by the sealing material, which is introduced into the injection through-passage channel and passes out of the injection channel, for example, via the outlet opening, such that the press-fit locations are permeable to the sealing material.

Furthermore, the hollow-profile strip preferably has at least two mutually opposite inner supporting walls in the interior, these walls expediently each likewise having a point of inflection. The inner supporting walls are particularly preferably designed to be thinner than the side walls.

According to a particular embodiment of the invention, the top wall of the hollow valve profile is of concave duct-like design in cross section and forms a duct at least in the region of the outlet opening. Under compressive loading of the sealing material, the top wall descends particularly far downwards and, in the process, draws the peripheral regions to the centre, with the result that the valve-seat edges and sealing lips between the hollow valve profile and the side walls of the valve-seat channel are permeable to sealing material.

The invention also relates to a sealing device for sealing joints between abutting concrete structures, in particular using a sealing device described above, having an injection-channel body with an injection channel for the introduction of sealing material, the injection channel having at least one outlet opening for the sealing material, a covering strip which prevents material from penetrating through the outlet opening into the injection channel, and a swellable strip, the covering strip being formed in one piece with the swellable strip. The covering strip here is preferably a stop-valve strip.

Forming the stop-valve strip in one piece with the swellable strip is particularly advantageous because the assembly of the sealing device according to the invention is then limited essentially to two parts being joined together.

The swellable strip is arranged essentially on the joint side of the stop-valve strip, such that it does not disrupt the functioning of the channel arrangement. The comparatively soft swellable strip compensates for any possible small unevenesses in the surface of the concrete joint and swells into spaces which are devoid of material, this resulting in provisional sealing.

The swellable strip is expediently arranged on the covering or stop-valve strip, outside the channel body.

According to a preferred embodiment of the invention, the swellable strip is fixed, for example adhesively bonded, to the bottom wall of the hollow-profile strip.

The swellable strip may be connected to the covering or stop-valve strip at a first production site, it being possible for the operation of joining the strip together with the channel arrangement to take place at a second production site or at the construction site.

The swellable strip is expediently a flat, flexible, relatively soft strip and preferably projects laterally beyond the channel arrangement, peripheral crosspieces being produced as a result. The peripheral crosspieces are preferably angled some way in the direction of the envisaged joint-bearing region, this resulting in a kind of curvature in the transverse direction. When the sealing device is applied to the concrete surface of a concrete abutment structure, the peripheral crosspieces will come into contact with the surface in the first instance. When the sealing device is then pressed against the concrete abutment structure, for example by being nailed firmly thereon, a central section of the swellable strip also comes into contact with the surface. Thereafter, the free longitudinal edges of the side walls of the channel body are expediently seated on the peripheral crosspieces, this resulting in sealing against material or liquid, such as water or cement slurry, penetrating into the channel body.

An exemplary embodiment of the invention is explained in more detail hereinbelow with reference to the figures, in which:

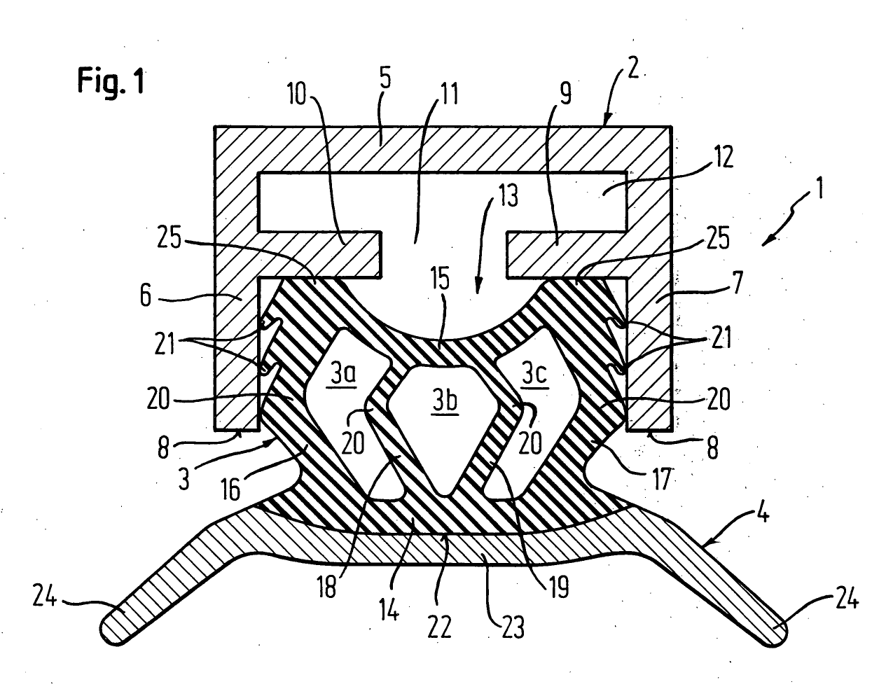

FIG. 1 shows a cross section through a sealing device according to the invention in the state in which it is sold; and

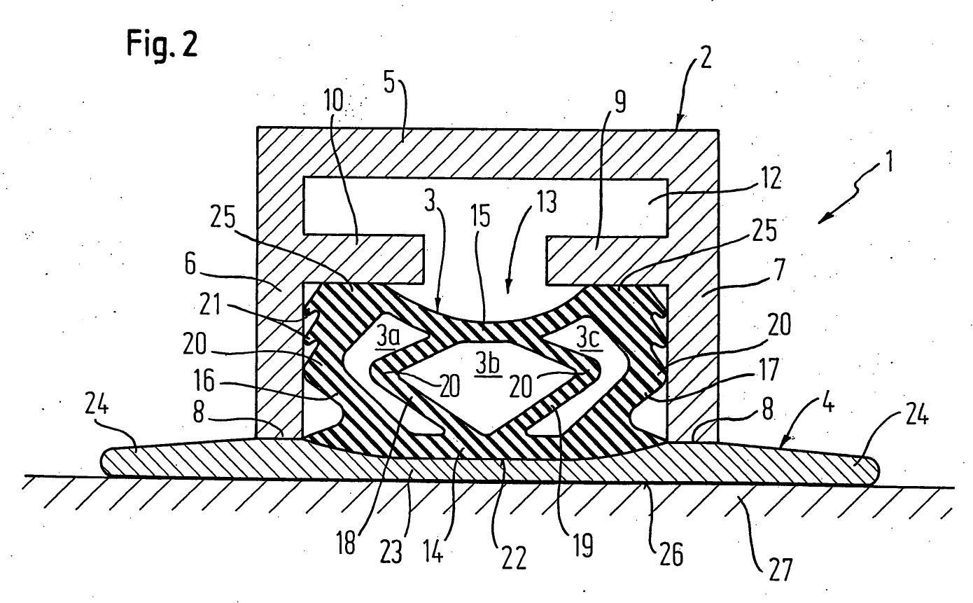

FIG. 2 shows a cross section through the sealing device from FIG. 1 once laid in position.

The sealing device 1 essentially comprises a relatively stiff channel body 2 made of plastic, a tubular hollow-profile strip 3, which is seated in the channel body 2 and forms a stop valve, and a swellable strip 4.

The channel body 2 consists, for example, of polyethylene, in particular of high-density polyethylene (HDPE). The profile strip 3 consists, for example, of rubber or of polyethylene, in particular HDPE, or of polyvinyl chloride (PVC) or of polyurethane. The swellable strip 4 consists, for example, of swellable rubber or of swellable plastic, in particular swellable polyurethane.

The channel body 2 has a U-shaped cross section, the U-shape being open in the direction of a joint region which is to be sealed.

The channel body 2 has a top wall 5 and two side walls 6, 7, the side walls 6, 7 being of equal length and their free ends forming longitudinal edges 8.

Integrally formed on the inside of the walls 6, 7 are longitudinally extending intermediate-wall crosspieces 9, 10 which project preferably at right angles from these walls and leave a longitudinal slot 11 free between them.

An injection channel 12 is formed above the intermediate-wall crosspieces 9, 10; a valve-seat channel 13, which is open in the direction of the joint region, is located beneath.

The cross-sectional shape of the channel body 2 may also be designed to be arcuate or trapezoidal or polygonal or the like, although free longitudinal edges 8 should be present. A plurality of injection channels 12 may also be provided. Instead of the longitudinal slot 11, it is also possible to provide a perforation or similar outlet openings.

Mounted in the valve-seat channel 13 is the hollow valve profile strip 3, which consists of a compliant, plasticized, preferably vulcanized, elastomeric material.

The tubular hollow valve profile strip 3 has three through-passage channels 3a, 3b, 3c, a bottom wall 14, a top wall 15, two side walls 16, 17 and, in the interior, in each case one supporting wall 18, 19, which is adjacent to, and spaced apart from, a side wall 16 or 17. The walls 16, 18 and 17, 19—as seen in cross section—are angled outwards in each case like arrows to form a corner region of inflection 20 in each case. The purpose of the corner regions of inflection 20 will be explained at a later stage in the text.

Longitudinally extending sealing lips 21 are integrally formed on the outside and between in each case the corner region of inflection 20 of the side walls 16, 17 and the top wall 15, these sealing lips butting in a sealing manner against the inside of the side walls 6, 7 in the valve-seat channel 13.

The corner regions of inflection 20 of the side walls 16, 17 of the hollow valve profile strip 3 likewise butt against the inside of the side walls 6, 7 of the channel body 2 and are supported there in the region of the longitudinal edges 8.

Before the sealing device has been laid in position (FIG. 1), the bottom wall 14 and at least some regions of those sections of the walls 16, 18, 19, 17 which extend from the bottom wall 14 to the regions of inflection 20 project out of the valve-seat channel 13.

The top wall 15 of the hollow valve profile strip 3 is expediently designed to be concave in cross section and duct-like in the longitudinal direction. The bottom wall 14, in contrast, has an essentially planar surface.

Transition regions 25 between in each case the top wall 15 and the side walls 16, 17 strike against the intermediate-wall crosspieces 9, 10.

According to one embodiment of the invention, the valve strip 3 is formed in one piece with a swellable strip 4. According to the exemplary embodiment illustrated, the swellable strip 4 is arranged on the joint-side outer surface 22 of the bottom wall 14. The swellable strip 4 is preferably fixed to the outer surface 22 of the bottom wall 14. For example, the valve strip 3 is connected to the swellable strip 4 by coextrusion or by vulcanization. The swellable strip 4 is designed as a flat strip and is wider than the bottom wall 14, this resulting in laterally projecting peripheral crosspieces 24 which are angled some way in the direction of a bearing surface 26.

If required, the projecting peripheral crosspieces 24 of the swellable strip 4 may be designed to be narrower or wider than the exemplary embodiment illustrated in the figures, in order for a sufficient quantity of swellable material to be provided, for example, depending on the application. The width of the peripheral crosspieces 24 can vary in the longitudinal direction, for example in order to allow the sealing device to be laid in position particularly straightforwardly on a corner region of the concrete foundation 27.

The swellable strip 4 may have protuberances or similar structural means on the joint side, with the result that it has particular non-slip properties when laid in position on a concrete surface 26.

The thickness of the swellable strip 4, in particular in the central section 23, corresponds approximately to the thickness of the bottom wall 14, the walls 5, 6, 7, 9, 10, 14, 15, 16, 17 expediently being designed to be of approximately equal thickness.

The operation of laying the sealing device 1 in position is described hereinbelow. For example, the joint between a horizontal concrete foundation 27 and a vertical concrete wall (not illustrated) is formed. In the joint region between the concrete foundation and the concrete wall which is to be erected thereon, the sealing device 1 is laid in position on the surface 26 of the concrete foundation 27, the peripheral crosspieces 24 of the swellable strip 4 resting on the concrete foundation 27. The sealing device 1 is secured on the concrete foundation 27, for example clamped or nailed firmly in a manner known per se. In this case, the swellable strip 4 fits closely, essentially over the entire surface area, against the surface 26 of the concrete foundation 27 and the hollow valve profile strip 4 is compressed, the longitudinal edges 8 of the channel body 2 preferably being seated in a sealing manner on the peripheral crosspieces 24 of the swellable strip 4. The sealing lips 21 and the points of inflection 20 of the side walls 16, 17 are pressed firmly and in a sealing manner against the side walls 6, 7, as a result of which the definitive valve seat is produced and, on account of the press fit, it is not possible for any liquid to penetrate into the injection channel 12. The transition regions 25 are likewise pressed in a sealing manner against the intermediate-wall crosspieces 9, 10 (FIG. 2).

The functioning of the sealing device 1 in the joint is described hereinbelow. A liquid sealing material which is known per se is introduced under pressure, in a manner known per se, into the injection channel 12. The sealing material penetrates through the longitudinal slot 11 into the valve-seat channel 12, in which case it presses on the concave top wall 15. The top wall 15 yields to the pressure and is moved in the direction of the joint and the corner regions of inflection 20 inflect inwards. The top wall 15 carries along the sealing lips 21 and the section of the side walls 16, 17 including the corner region of inflection 20 in the inward direction, with the result that the sealing action is eliminated and sealing material can be pressed through between the side walls 6, 7 and the profile strip 3, and between the bottom edges 8 and the swellable strip 4, and can penetrate into voids of the joint.

The higher the pressure to which the top wall 15 is subjected by the sealing material, the lower is the pressure to which the intermediate-wall crosspieces 9, 10 are subjected by the peripheral sections 25 of the top wall 15 of the hollow valve profile strip 3 and the lower is the pressure to which the side walls 6, 7 are subjected by the sealing lips 21 and the corner regions of inflection 20, with the result that the sealing material, subjected to pressure, moves between the peripheral sections 25 of the top wall 15 and the intermediate-wall crosspieces 9, 10 and forces its way via the backs of the sealing lips 21, and past the corner regions of inflection 20 of the side walls 16, 17, out of the valve-seat channel 13, via the longitudinal edges 8 of the side walls 6, 7, into voids of the joint.

When water and/or moisture enters into the joint, the water comes into contact with the swellable strip 4. The swellable material of the swellable strip 4 swells up and blocks further access for the water. The water and/or the swellable material are prevented from penetrating into the valve-seat channel 13 or even into the injection channel 12, in particular because the longitudinal edges 8 of the side walls 6, 7 are seated firmly on the bottom wall 14 of the hollow valve profile strip 3 and/or on the swellable strip 4. Even if the water and/or the swellable material penetrate into the valve-seat channel 13, however, the side walls 16, 17 of the hollow valve profile strip 3, in interaction with the side walls 6, 7 of the channel body 2, block the path to the injection channel 8. In particular, the side walls 16, 17 in the corner region of inflection 20 and the sealing lips 21 press in a sealing manner against the side walls 6, 7 of the channel body 2. This effectively prevents water, moisture, cement slurry or other contaminants from penetrating into the injection channel 12.

1. Sealing device for sealing joints between structural bodies, and particular between abutting concrete structres, having
an injection-channel body (2) which is to be fitted on a surface (26) of one of the structural bodies and has an injection channel (12) for the introduction of sealing material; the injection channel (12) having, on the joint side, at least one outlet opening (11) for the sealing material, and,
a covering strip which prevents material from penetrating through the outlet opening (11), into the injection channel (12), from the joint side, characterized in that the covering strip is a stop-valve strip (3) in the form of a hollow-profile strip.

2. Sealing device according to claim 1, characterized in that the hollow-profile strip (3) is designed, in particular structured, such that the hollow-profile strip (3) preferably yields in a predetermined manner and reduces its cross-sectional area, when injection material from the injection channel (12) subjects the hollow-profile strip (3) to pressure, such that the injection material moves out of the sealing device (1), under the pressure, in the lateral direction past the hollow-profile strip (3) with the reduced or tapered cross section.

3. Sealing device according to claim 1 and/or 2, characterized in that the channel body (2), adjacent to the injection channel (12), has a valve-seat channel (13) for accommodating the stop-valve strip (3), the injection channel (12)” being connected to the valve-seat channel (13) by way of the outlet opening (11).

4. Sealing device according to one of claims 1 to 3, characterized in that the stop-valve strip (3) has walls (15, 16, 17) which are supported with a press fit on associated walls (6, 7, 9, 10) of the valve-seat channel (13).

5. Sealing device according to claim 4, characterized in that the side walls (6, 7) of the valve-seat channel (13) are of equal length.

6. Sealing device according to claim 5, characterized in that the free ends of the side walls (6, 7) form longitudinal edges (8).

7. Sealing device according to one of claims 3 to 6, characterized by intermediate-wall crosspieces (9, 10) which are integrally formed on the side walls (6, 7).

8. Sealing device according to one of claims 1 to 7, characterized in that the outlet opening (11) is designed as a slot between the free ends of the intermediate-wall crosspieces (9, 10).

9. Sealing device according to one of claims 3 to 8, characterized in that the hollow-profile strip (3) has narrow longitudinal surfaces and/or longitudinal edges which are integrally formed, in particular, laterally on the hollow-profile strip (3) and are supported on associated walls of the valve-seat channel (13).

10. Sealing device according to one of claims 3 to 9, characterized in that the hollow-profile strip (3) has at least two inflected walls (16, 17, 18, 19) which connect a bottom wall (14) to a top wall (15) and which have a region of inflection (20) which forms a predetermined point of inflection.

11. Sealing device according to claim 10, characterized in that the entire bottom wall (14) projects out of the valve-seat channel (13) when the sealing device (1) is free, in particular when it has not been laid in position.

12. Sealing device according to claim 10 or 11, characterized in that two mutually opposite inflected walls (16, 17) of the hollow-profile strip (3) form side walls which are supported, in the region of inflection (20), on the associated side walls (6, 7) of the valve-seat channel (13).

13. Sealing device according to one of claims 10 to 12, characterized in that sealing lips are integrally formed on the side walls (16, 17) of the hollow-profile strip (3), between the region of inflection (20) and the top wall (15) of the hollow-profile strip (3), the sealing lips interacting in a sealing manner with the associated side wall (6, 7) of the valve-seat channel (13).

14. Sealing device according to one of claims 1 to 13, characterized in that the hollow-profile strip (3) has at least two mutually opposite supporting walls (18, 19) in the interior.

15. Sealing device according to claim 14, characterized in that the supporting walls (18, 19) are designed to be thinner than the side walls (16, 17).

16. Sealing device according to one of claims 10 to 15, characterized in that the top wall (15) of the hollow valve profile (3) is of concave design and forms a duct in the region of the outlet opening (11) in the valve-seat channel (13).

17. Sealing device according to one of claims 1 to 16, characterized in that the stop-valve strip (3) consists of a compliant material.

18. Sealing device according to one of claims 1 to 17, characterized in that the stop-valve strip (3) consists of elastomeric material.

19. Sealing device according to one of claims 1 to 18, characterized in that the stop-valve strip (3) consists of a plasticized, preferably vulcanized material.

20. Sealing device according to one of claims 1 to 19, characterized in that the hollow-profile strip (3) is designed with a plurality of through-passage channels (3a, 3b, 3c).

21. Sealing device for sealing joints between structural bodies, in particular between abutting concrete structures, in particular according to one of claims 1 to 20, having
an injection-channel body (2) with an injection channel (12) for the introduction of sealing material, the injection channel (12) having an outlet opening (11) for the sealing material,
a covering strip (3) which prevents material from penetrating through the outlet opening (11) into the injection channel (12), and
a swellable strip (4),
characterized in that the covering strip (3) is formed in one piece with the swellable strip (4).

22. Sealing device according to claim 21, characterized in that the swellable strip (4) is arranged on the joint side of the covering strip (3).

23. Sealing device according to claim 22, characterized in that the swellable strip (4) is adhesively bonded to the covering strip (3).

24. Sealing device according to one of claims 21 to 23, characterized in that the swellable strip (4) has peripheral crosspieces (24) which project laterally beyond the covering strip (3) and which are preferably angled some way in the direction of the envisaged joint-bearing region (26).

25. Sealing device according to one of claims 21 to 24, characterized in that the peripheral crosspieces (24) of the swellable strip (4) can be moved out of the angled position, counter to prestressing, such that the swellable strip (4), with the peripheral crosspieces (24), has an overall planar bearing surface, in particular in the installed state.

26. Sealing device according to one of claims 21 to 25, characterized in that the longitudinal edges (8) of the channel body (2) are supported on the peripheral crosspieces (24) when the sealing device (1), in particular in the installed state, is fastened on the envisaged joint-bearing region (26).

27. Hollow-profile strip for a sealing device for equipping an injection channel of an injection-channel body, the injection channel being arranged in a joint region between structural bodies, in particular between two sections which are to be concreted together, for the purpose of blocking the channel against the penetration of slurry during the concreting, characterized in that the hollow-profile strip (3) is designed, in particular structured, such that the hollow-profile strip (3) preferably yields in a predetermined manner and reduces its cross-sectional area, when injection material from the injection channel (12) subjects the hollow-profile strip (3) to pressure, such that the injection material moves out of the sealing device (1), under the pressure, in the lateral direction past the hollow-profile strip (3) with the reduced or tapered cross section.

28. Hollow-profile strip according to claim 27, characterized in that the hollow-profile strip has walls (15, 16, 17) and narrow longitudinal surfaces and/or longitudinal edges which are integrally formed, in particular, laterally on the hollow-profile strip (3) for support on associated walls of a valve-seat channel (13).

29. Hollow-profile strip according to claim 27 and/or 28, characterized in'that the hollow-profile strip (3) has at least two inflected walls (16, 17, 18, 19) which connect a bottom wall (14) to a top wall (15) and which have a region of inflection (20) which forms a predetermined point of inflection.

30. Hollow-profile strip according to claim 29, characterized in that two mutually opposite inflected walls (16, 17) of the hollow-profile strip (3) form side walls for support, in the region of inflection (20), on associated side walls (6, 7) of a valve-seat channel (13).

31. Hollow-profile strip according to claim 29 and/or 30, characterized in that sealing lips are integrally formed on the side walls (16, 17) of the hollow-profile strip (3), between the region of inflection (20) and the top wall (15), the sealing lips being intended for performing a sealing action with associated side walls (6, 7) of a valve-seat channel (13).

32. Hollow-profile strip according to one or more of claims 27 to 31, characterized in that the hollow-profile strip (3) has at least two mutually opposite supporting walls (18), (19) in the interior.

33. Hollow-profile strip according to claim 32, characterized in that the supporting walls (18), (19) are designed to be thinner than the side walls (16), (17).

34. Hollow-profile strip according to one or more of claims 27 to 33, characterized in that the top wall (15) of the hollow-profile strip (3) is of concave design and forms a duct.

35. Hollow-profile strip according to one or more of claims 27 to 34, characterized in that the hollow-profile strip (3) consists of a compliant material.

36. Hollow-profile strip according to claim 35, characterized in that it consists of elastomeric material.

37. Hollow-profile strip according to claim 35 and/or 36, characterized in that it consists of a plasticized, preferably vulcanized material.

38. Hollow-profile strip according to one or more of claims 27 to 37, characterized in that the hollow-profile strip (3) is designed with a plurality of through-passage channels (3a), (3b), (3c).

39. Hollow-profile strip according to one or more of claims 27 to 38, characterized in that a swellable strip (4) is arranged on the hollow-profile strip (3).

40. Hollow-profile strip according to claim 39, characterized in that the swellable strip (4) is arranged on the joint-side outer surface of the bottom wall (14).

41. Hollow-profile strip according to claim 40, characterized in that the swellable strip (4) is adhesively bonded to the covering strip (3).

42. Hollow-profile strip according to one or more of claims 39 to 41, characterized in that the swellable strip (4) has peripheral crosspieces (24) which project laterally beyond the hollow-profile strip (3).

43. Hollow-profile strip according to claim 42, characterized in that the peripheral crosspieces (24) are angled away from the bottom wall (14).

44. Hollow-profile strip according to claim 42 and/or 43, characterized in that the peripheral crosspieces (24) of the swellable strip (4) can be moved out of the angled position, counter to prestressing, such that the swellable strip (4), with the peripheral crosspieces (24), forms an overall planar bearing surface, in particular in the installed state.
